(19) United States
(12) Patent Application Publication
(10) Pub. No.: US 2025/0136482 A1
(43) Pub. Date: May 1, 2025

(54) Process and System for Treatment of Water Containing Dissolved Metals

(71) Applicant: Muddy River Technologies Inc., Delta (CA)

(72) Inventors: Robert John Stephenson, Vancouver (CA); Michael Stephen Gardner, Delta (CA); Travis David Wayne Reid, Vancouver (CA)

(73) Assignee: Muddy River Technologies Inc., Delta, BC (CA)

(21) Appl. No.: 18/837,535

(22) PCT Filed: Feb. 15, 2022
(86) PCT No.: PCT/CA2022/050216

§ 371 Date: Aug. 9, 2024

(51) Int. Cl. C02F 1/463; C02F 1/00; C02F 1/24; C02F 1/461; C02F 1/52; C02F 1/66; C02F 101/10; C02F 101/20

(52) U.S. Cl. CPC C02F 1/463; C02F 1/46114; C02F 1/5281; C02F 1/66; C02F 1/004; C02F 2001/007; C02F 1/24; C02F 2001/46152; C02F 2101/106; C02F 2101/203; C02F 2201/4616; C02F 2301/08

(57) ABSTRACT

A process and system for effective treatment of a water stream containing dissolved metal contaminants. The process and system employ the electrocoagulation principle to enable precipitation of the dissolved metal contaminants and provide sufficient residence time for completion of the precipitation process so that flocs of the dissolved metal contaminants that can be easily separated are generated thereby resulting in effective treatment of the water stream.

### FIELD

Embodiments described herein relate to a process for treatment of water containing dissolved metals. More particularly, embodiments described herein relate to a process for treating water based on the electrocoagulation principle. A corresponding system is also described.

### BACKGROUND

Discharge of water or wastewater that contains elevated concentrations of dissolved metals/metal contaminants into fresh and marine receiving waters is a major health and environmental concern. Many metals are toxic or carcinogenic and tend to accumulate in the environment and in living organisms since they are not biodegradable. To minimize negative impacts on the environment and living organisms, discharge of wastewaters generated during industrial processes, such as mining and semiconductor manufacturing and containing dissolved metal contaminants, into the environment is strictly regulated. Reducing concentrations of dissolved metal contaminants, while beneficial to protecting living organisms and the environment, also enables reuse of the treated water and potential recovery of the dissolved metals. Known methods for reducing concentrations of dissolved metal contaminants in discharged wastewaters to meet the strictly regulated discharge criteria are discussed below.

One known method is chemical precipitation. In this method, wastewaters are treated with precipitating agents or reagents to change the pH of wastewaters and precipitate the dissolved metal contaminants in an insoluble form such as hydroxides or sulphides. The precipitates are then removed by physical solids separation methods such as gravity settling, flotation or filtration. Reagents which are typically used include lime (calcium hydroxide), sodium hydroxide, potassium hydroxide, sodium sulphide, hydrogen sulphide, calcium carbonate, sodium carbonate or ferrous iron.

One of the disadvantages of chemical precipitation is that not all dissolved metal contaminants can be precipitated under one set of chemical conditions. For example, when wastewater containing arsenic and magnesium is treated with sulphide, precipitates of arsenic are formed but precipitates of magnesium are not formed. To remove magnesium, the wastewater will have to be further treated with another reagent such as lime to form precipitates of magnesium hydroxide. More than one stage of chemical precipitation and solids separation is generally needed for wastewater containing dissolved metal contaminants having very different precipitation characteristics, for example, very different minimum solubility pH values.

Secondly, in a chemical precipitation process, generally large amounts of reagents are used which can render the process expensive.

Thirdly, chemical precipitation with the above discussed reagents have associated handling, processing, and waste disposal challenges. Two examples are discussed below.

The reagent lime (calcium hydroxide) is in the form of a dry powder and is mixed with water to form a slurry before it is added to wastewater. When in contact with moisture in air, lime powder tends to form clumps creating handling, conveyance, and dosing difficulties. Since lime is poorly soluble in water, agitation by pumps or mixers is required to keep lime solids in suspension. Poor solubility also causes lime buildup on conveyance and dosing equipment, causing fouling of such equipment. Further, due to its poor solubility, excess lime is generally added into wastewater, producing correspondingly more waste for disposal which is a significant on-going cost and liability.

To summarise, preparing a consistent lime slurry requires dry air conditions, slurry mixing and pumping equipment, and frequent operator intervention for reliable solids handling. It may be difficult to reliably achieve such handling and process conditions in some industrial processes such as mining to treat water to required levels to protect the environment and meet regulatory compliance.

Mines are, typically, located in areas with extreme climatic conditions. Therefore, maintaining lime in its dry form will be difficult in such conditions. Further, installation of equipment needed to produce a consistent lime slurry, and providing resources such as electricity, fuel, and trained personnel to operate such equipment will be costly and difficult to implement. The above factors are compounded by the fact that mines are typically located in areas far from urban centers, making it difficult and costly to install and provide the required equipment and resources.

Sodium sulphide and hydrogen sulphide are used to treat wastewater and precipitate the dissolved metal contaminants as insoluble metal sulphides. However, these sulphide reagents are extremely toxic and difficult to handle, releasing hydrogen sulphide (H₂S) gas under acidic conditions which are common at mines. Since sulphide does not remove acidity, treated mine water may require further treatment such as lime addition to neutralize its pH prior to its discharge to the environment.

Another known method for reducing concentrations of dissolved metal contaminants in wastewater is electrocoagulation (EC). A conventional EC process utilizes an EC cell which houses an electrode assembly. The electrode assembly includes one or more pairs of anode and cathode electrodes in the form of plates or blocks. In each pair, the anode and electrode are separated by an electrode gap, are in contact with the wastewater to be treated, and are connected to an electrical power source. In the conventional EC process, the wastewater provides the electrical conductivity for completion of the electric circuit across the electrode gap between the anode and the cathode. When power is applied, the anode dissolves to generate in-situ coagulants which neutralize surface charges of contaminants, thereby enabling their agglomeration into larger flocs that can be easily separated from the treated wastewater.

Since coagulants are generated in-situ, reagent handling issues associated with the chemical precipitation process, discussed above, are avoided. Further, an EC process results in the generation of a smaller and chemically stable volume of by-products, thereby making waste disposal easier compared to chemical precipitation.

Despite the advantages stated above, a conventional EC process suffers from shortcomings that limit its utility.

An EC process, primarily, enables coagulation or agglomeration of suspended contaminants, i.e., contaminants that are non-soluble or poorly soluble in wastewaters. An EC process can be adapted to remove dissolved contaminants by creating chemical conditions, in an EC cell, where the dissolved contaminants are at their lowest solubility. The chemical conditions are created, for example, by generating in-situ coagulants which react with the dissolved contaminants which alter or change the chemical characteristics of the wastewater being treated, such as its pH value or reduction oxidation (redox) values or both.

Applicant has discovered that while said chemical conditions that lead to precipitation of the dissolved contaminants can be created in an EC cell, because the residence time of the wastewater in an EC cell is so short, chemical reactions that result in precipitation of dissolved contaminants into flocs of a desired size and density so they can be easily separated from treated water are not completed. This renders the EC process less effective for treatment of wastewater containing dissolved contaminants, such as wastewaters discharged from mines containing dissolved metal contaminants.

In detail, the typical residence time of wastewater in an EC cell ranges from less than ten (10) seconds to about one (1) minute. Applicant believes and has observed that while this residence time is sufficient for electrochemical reactions to be completed, the residence time is insufficient for the chemical reactions under conditions that are initiated by the electrochemical reactions to be completed. Chemical reactions are generally much slower than electrochemical reactions. As used herein, “electrochemical reactions” occur in the EC cell and include, but are not limited to, dissolution of the anode into the wastewater, hydrolysis, formation of in-situ coagulants or changes of pH and oxidation reduction (redox) potential values of the wastewater. As used herein, “chemical reactions” include, but are not limited to, reactions that enable precipitation, development of the precipitates and agglomeration of the precipitates to flocs of a desired density and size.

For reasons stated above, Applicant also believes that, the above-described conventional EC process may not work effectively to treat wastewater containing multiple or a range of dissolved metal contaminants since the residence time in the EC cell will not be sufficient to complete the range of chemical reactions required to precipitate the dissolved metal contaminants.

Applicant has also observed that the above-described EC cell does not effectively treat wastewater having low electrical conductivity, for example, mine waters which have an electrical conductivity between 0.1 mS/cm to 1.0 mS/cm. In the above-described EC cell, the wastewater provides electrical conductivity between the anode and the cathode for completion of the electric circuit between the anode and the cathode. If the electrical conductivity of the wastewater is low, higher voltages will have to be supplied to the above-described EC cell to complete the electric circuit to generate the current required to dissolve the anode and thus provide wastewater treatment. This results in increased power consumption and operational costs, including a propensity for electrode fouling under higher voltages.

Further, the electrode gap in the above-described EC cell also limits the EC cell's volumetric capacity thereby making it poorly suited to treat large and variable volumes of wastewater. The electrode gap between the anode and the cathode must kept small, typically less than 1 inch and preferably less than ¼ inch. An increased electrode gap either requires the wastewater to have very high electrical conductivity or requires supply of high voltage to complete the electric circuit between the anode and cathode. These options are either not possible or undesirable. Therefore, the requirement to maintain a small electrode gap makes scalability of the above-described EC cell to treat large and variable volumes of wastewater complex. The above-described EC cell also requires constant maintenance due to buildup of by-products on the electrode surfaces, and frequent electrode gap re-adjustment due to anode dissolution which increases the electrode gap.

Alternative EC cell configurations which address the above-discussed issues related to low electrical conductivity, scalability and maintenance are known. In such alternative EC cell configurations, the anode plate or block is replaced by a bed of metal pellets which functions as a consumable anode, thus doing away with the electrode gap. However, such EC configurations also do not provide the residence time required to complete the chemical reactions for effective precipitation of dissolved metal contaminants.

There is a need for a system and process which can effectively precipitate dissolved contaminants contained in large and variable volumes of discharged waters, and which system and process can be implemented at low costs and minimal operator intervention and in remote areas.

### SUMMARY

Accordingly, in one embodiment a system for treating a water stream for reducing concentrations of at least a first set of dissolved metal contaminants contained in the water stream is provided. The water stream has a first set of chemical characteristics. The system comprises an electrocoagulation (EC) cell having at least an electrode assembly. The EC cell is adapted to receive the water stream and change the first set of chemical characteristics of the water stream to a second set of chemical characteristics to enable precipitation of the first set of dissolved metal contaminants. The system also comprises a reactor operatively coupled to the EC cell. The reactor is adapted to receive the water stream from the EC cell as an intermediate water stream. The reactor is also adapted to provide a pre-determined residence time to the intermediate water stream to facilitate completion of the precipitation of the first set of dissolved metal contaminants and formation of flocs of a desired density and size which can be easily separated from the intermediate water stream to generate a treated intermediate water stream.

Accordingly, in another embodiment a corresponding method is also provided. The method comprises providing the system described above. The method further comprises receiving, in the electrocoagulation (EC) cell, the water stream, and in the EC cell, forming in-situ coagulants and changing the first set of chemical characteristics of the water stream to the second set of chemical characteristics for enabling the precipitation of the first set of dissolved metal contaminants. Further, the method comprises receiving in the reactor the water stream from the EC cell as the intermediate water stream. The method also comprises retaining the intermediate water stream in the reactor for the pre-determined residence time while maintaining the second set of chemical characteristics for facilitating the completion of the precipitation of the first set of dissolved metal contaminants and formation of the flocs of the desired density and size. Finally, the process comprises removing the flocs from the intermediate water stream to generate the treated intermediate water stream.

### BRIEF DESCRIPTION OF THE DRAWINGS

FIG. 1 is a schematic representation of one embodiment of the system described herein, FIG. 1 depicts an electrocoagulation (EC) cell operatively coupled to a reactor;

FIG. 2 is a schematic representation of one configuration of the EC cell of the system of FIG. 1;

FIG. 3 is a schematic illustrating an implementation of the system of FIG. 1, the implementation treating a water stream containing concentrations of dissolved iron and lithium;

FIG. 4 is a schematic illustrating another implementation of the system of FIG. 1, the implementation treating a water stream containing concentrations of dissolved cadmium, copper, zinc and antimony; and

FIG. 5 is a schematic illustrating yet another implementation of the system of FIG. 1, the implementation treating a water stream containing concentrations of dissolved selenium (selenate).

### DETAILED DESCRIPTION

Embodiments described herein relate to treatment of a water stream containing dissolved metal contaminants using the electrocoagulation (EC) principle. In embodiments described herein, the water stream being treated is given sufficient residence time or dwell time for chemical reactions initiated within the water stream by the EC principle to be completed so as to effectively convert the dissolved metal contaminants contained within the water stream to an insoluble form thereby resulting in effective treatment of the water stream.

The water stream may include, but is not limited to, wastewaters discharged from industrial processes such as oil and gas production, mining or metal fabrication, water from underground brine pools, landfill leachate or water from contaminated sites requiring remediation.

The dissolved metal contaminants may include, but are not limited to, aluminum, arsenic, antimony, cadmium, copper, chromium, iron, lead, lithium, magnesium, mercury, nickel, phosphorus, selenium, uranium or zinc.

Concentrations of dissolved metal contaminants in the water stream depend upon the source of the water stream. In one embodiment, the source is a coal mine containing concentrations of dissolved selenium (selenate) in excess of 600 ppb. In another embodiment, the source is a gold and silver mine containing concentrations of more than 80 ppb of dissolved aluminum, 20 ppb of dissolved antimony, 10 ppb of dissolved cadmium and 500 ppb of dissolved zinc.

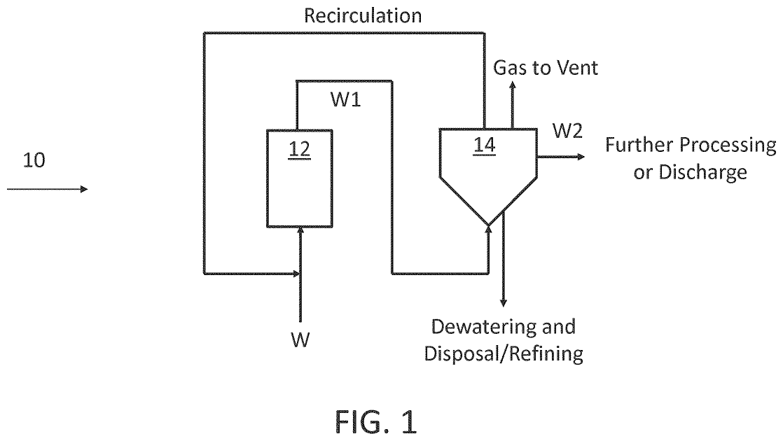

FIG. 1 provides an overview of one embodiment of the treatment system described herein. With reference to FIG. 1, treatment system 10 includes an electrocoagulation (EC) cell 12 which is operatively coupled to a reactor 14. A water stream to be treated W and containing dissolved metal contaminants is first received in the EC cell 12. The EC cell functions in a known manner where dissolved metal anode coagulants are formed which react with the dissolved metal contaminants and alter or change a first set of chemical characteristics of the water stream W. Conditions for enabling precipitation of the dissolved metal contaminants are created in the EC cell 12. Change in the chemical characteristics of the water stream W may include, but is not limited to, changes to its pH value or oxidation reduction (redox) potential value or changes to each of these values or presence of concentrations of the dissolved anode such as, but not limited to, presence of concentrations of iron, aluminum or magnesium. In this embodiment, the residence time in the EC cell 12 is less than 10 seconds and up to about one (1) minute.

Water stream W, after treatment and destabilization in the EC cell 12, enters the reactor 14 as an intermediate water stream W1. The intermediate water stream W1 has the changed chemical characteristics, namely a second set of chemical characteristics. The intermediate water stream W1 is retained in the reactor 14 for a pre-determined period of time such as a pre-determined residence or dwell time, while maintaining its changed chemical characteristics such that chemical reactions initiated within the EC cell 12 for precipitation of the dissolved metal contaminants are completed. These chemical reactions result in precipitation of the dissolved metal contaminants, development of precipitates and agglomeration of precipitates into flocs of a density and size, which permit separation of the flocs from the intermediate water stream W1 by known physical separation methods. In one embodiment, the density of the flocs ranges from about 0.9 g/ml to about 2.0 g/ml, and the size ranges from less than 0.1 mm to about 10 mm in diameter. The flocs are dewatered and sent for refining or secure disposal. The treated intermediate water stream W2 is further processed or discharged to the environment or reused.

In one embodiment, separation of the flocs may occur in the reactor 14.

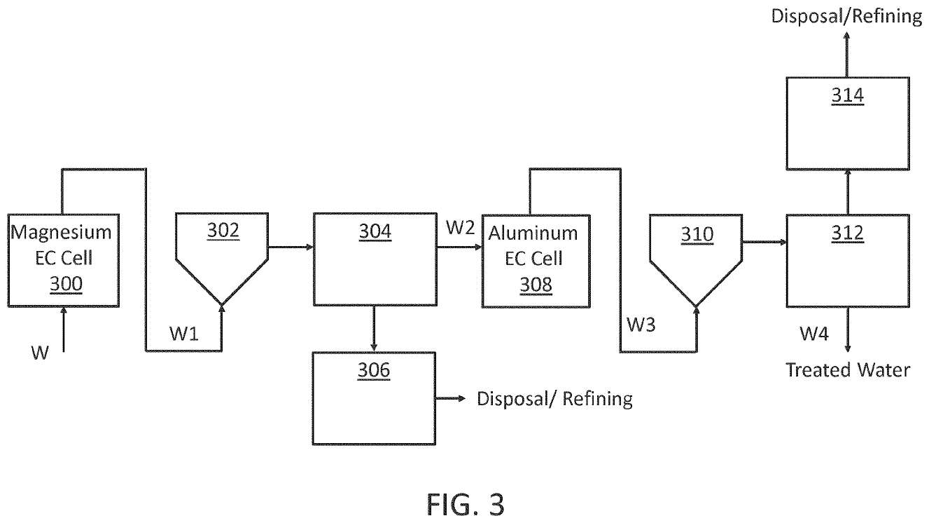

In another embodiment, separation of the flocs may occur in a separator (FIGS. 3 to 5) such as a gravity clarifier separator or a flotation separator or a filter which is operatively coupled to the reactor 14. In this embodiment, content of the reactor 14 may be removed periodically or continuously by a pump or other conveying device and directed to the separator for flocs separation. The separated flocs may be dewatered and may be disposed of, or metals contained in them may be recovered.

The residence time in the reactor 14 will vary depending on a multitude of factors including, but not limited to, the initial or first set of chemical characteristics of the water stream, types and concentrations of the dissolved metal contaminants contained in the water stream, precipitation reaction rates of the dissolved metal contaminants, and combinations thereof. As understood by one skilled in the art and as discussed above, chemical reactions are slower than electrochemical reactions, and since the chemical reactions are completed in the reactor 14, the volume of the reactor 14 should be such that it provides adequate time for the chemical reactions to be completed. In one embodiment, residence time in the reactor 14 ranges from less than 5 minutes to over two hours.

The increased residence time in the reactor 14 results in effective conversion of the dissolved metal contaminants into an insoluble form of a desired density and size, thereby enabling the solids to be easily separated from the treated water and resulting in effective treatment of the water stream.

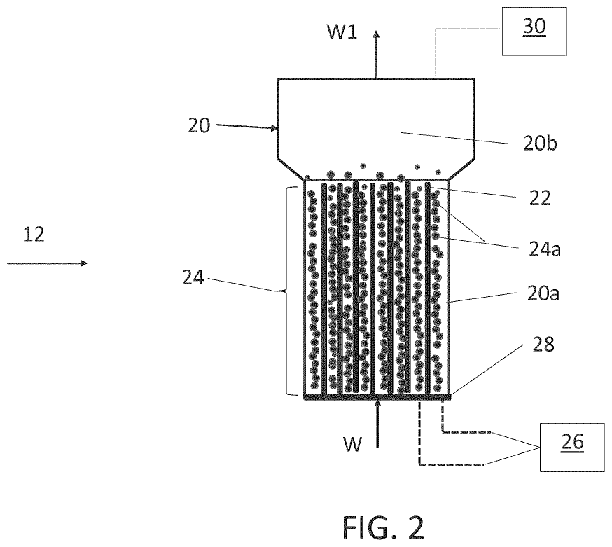

While any EC cell configuration can be used in conjunction with the reactor 14 to carry out the process described herein, an EC cell configuration (illustrated in FIG. 2) will now be described that has been found particularly suitable for the treatment of mine water. As one skilled in the art will understand, mine waters have low electrical conductivity, ranging from about 0.1 mS/cm to about 1.0 mS/cm. It should be understood that this exemplification of the EC cell configuration is not intended to be limiting since other EC cell configurations can be used, such as an EC cell configuration discussed in the Background where an electrode gap is maintained between the anode and cathode.

With reference to FIG. 2, the EC cell 12 includes a housing 20 defining two zones, a reactive zone 20a located below an expanded zone 20b. The reactive zone 20a houses an electrode assembly which includes multiple pairs of non-consumptive electrodes 22 supported within a reactive bed 24 formed of metal pellets 24a, which functions as a consumable anode. In each pair, the electrodes 22 are spaced apart and are separated by an electrode gap ranging from 1 cm to 10 cm. In one embodiment, the electrodes are in the form of rods made from titanium.

The electrodes 22 are stimulated by an electrical power source 26 through electrical headers 28 connected to the electrodes 22. In one embodiment, the electrical power source 26 is an AC power source having a capacity ranging from less than 15 amps to greater than 1,000 amps. The metal pellets 24a themselves provide the conduit for electrons to travel between the electrodes 22.

Valving arrangement 30 is provided for replenishment of the metal pellets 24a in the reactive bed 24. Non-conductive spacers (not shown) may be provided between the electrode rods 22 to prevent the electrodes 22 from contacting each other and causing electrical short circuiting in the EC cell 12.

In one embodiment, the metal pellets are made of magnesium, steel, iron or aluminum and are generally spherical in shape. However, other irregularly shaped pellets such as scrap metal pieces or shavings may be used. To prevent electrical short circuiting of the electrodes 22, the largest single dimension of the metal pellets 24a is less than half of the electrode gap between the electrodes 22 and is typically less than 0.5 mm and up to about 5 mm in diameter.

In one embodiment, the expanded zone 20b has a diameter that is greater than a diameter of the reactive zone 20a. In a preferred embodiment, a cross sectional area of the expanded zone 20b is double that of the reactive zone 20a.

Stimulation by the electrical power source 26 results in dissolution of the metal pellets 24a into the water stream W1 to form in-situ coagulants that react with dissolved metal contaminants and change the chemical characteristics of the water stream W from a first set of chemical characteristics to a second set of chemical characteristics which enable precipitation of dissolved metal contaminants. As one skilled in the art will understand, depending on the chemical characteristics of the water stream or types or concentrations of the dissolved metal contaminants contained therein, precipitation may be completed in the EC cell 12 and flocs of the desired density and size may be formed in the reactor 14 or precipitation may be initiated in the EC cell and completed in the reactor 14 and flocs of the desired density and size may be formed in the reactor 14 or any combination of the scenarios outlined above.

During operation of the EC cell 12, the water stream W first enters the reactive zone 20a and then flows into the expanded zone 20b. The upward velocity of the water stream W decreases in proportion to the increase of cross-sectional area of the expanded zone 20b thereby decreasing the up-flow suspension of undissolved metal pellets 24a. This results in the undissolved metal pellets 24a being retained in the EC cell 12 and not being washed out of the EC cell 12.

Applicant has observed that the EC cell configuration of FIG. 2 has the following advantages compared to an EC cell configuration where an electrode gap is maintained between the anode and cathode: working of the EC cell is not strongly impacted by the electrical conductivity of the water being treated. Since the metal pellets themselves largely provide the conduit for electrons to travel between the electrodes, even very low conductive water, for example less than 250 μs/cm, and highly conductive water, for example greater than 100 mS/cm, can be effectively treated. Since the consumable anode is in the form of an electrically charged packed bed, maintaining a consistent and small electrode gap is eliminated. Since the electrode gap is eliminated, volumetric capacity is not limited, and the EC cell of FIG. 2 may be scaled easily to treat large and variable volumes of water. Fouling is minimal since the metal pellets dissolve faster than they foul.

Gases formed in the EC cell 12 and reactor 14 are actively recovered or ventilated, by known processes and apparatus, for treatment or discharge as per health and safety regulations.

The treated intermediate water stream W2, in one embodiment, is recirculated through the EC cell 12, one or more times to increase volumetric flow through the EC cell 12 before it is discharged for further processing or release to the environment (FIG. 1). It has been observed by the Applicant that recirculation helps with the following: discharge of gases formed in the EC cell thereby maintaining a minimum gas holdup in the EC cell and decreasing voltage requirements since gases have low electrical conductivity; increases fluid velocity through the EC cell 12 to increase dissolution of the anode; better transport of precipitates formed in the EC cell 12 from the EC cell 12 thereby avoiding their accumulation in the EC cell 12, and faster completion of the electrochemical reactions thereby accelerating precipitation of the dissolved metal contaminants in reactor 14.

In one embodiment, the reactor 14 is a sealed vessel having a conical bottom. In this embodiment, the intermediate water stream W1 flows through the sealed vessel in an up flow pattern, from a bottom end of the sealed vessel to its top end. Piping or a baffle arrangement may be used to generate the up flow pattern. Applicant has observed that this up flow pattern aids inter-particle collision and agglomeration of the precipitates to form flocs of a size and density that permit their separation from the intermediate water stream W1.

In one embodiment, and as stated above, the reactor 24 is a sealed vessel, sealed to ambient environment. This configuration aids with creation of negative redox conditions of less than 0 mV ORP in the reactor 14 for management and recovery and discharge of gases, such as hydrogen gas, hydrogen sulphide gas, carbon monoxide gas, carbon dioxide gas or ammonia, produced during the electrochemical and chemical reactions as per health and safety regulations.

The reactor 14 described herein, in addition to providing the desired residence or dwell time, may also be used to complete other processes such as separation of flocs discussed above. Further, oxidation process(es) either to aid precipitation or increase dissolved oxygen concentration in the treated intermediate water stream W2 before it is discharged to the fresh water or marine environment may be carried out in the reactor. In one embodiment, to increase dissolved oxygen concentration positive redox conditions greater than 1 mV ORP are created in the reactor 14 in various ways. For example, positive redox conditions are created by introducing oxygen gas into the reactor 14 via a venturi injector (not shown) or by introducing enriched air or oxygen gas bubbles into the water stream in the reactor 14 or by converting the water stream in the reactor to a fine mist spray and contacting the mist spray with air or oxygen in a headspace in the reactor 14. As will be explained in the following paragraphs, positive redox conditions can also enhance precipitation of some dissolved metal contaminants.

Various implementations of the EC cell 12 and reactor 14 described above are contemplated. In one contemplated embodiment, the EC cell 12 and reactor 14 may be used to remove or reduce concentrations of a first set of dissolved metal contaminants from the water stream W. In this embodiment, the first set of dissolved metal contaminants may include single metal contaminants or may include mixed-metal contaminants having similar precipitation conditions or parameters.

In another contemplated embodiment, the water stream W may contain a first set of dissolved metal contaminants and a second set of dissolved metal contaminants having different or dissimilar precipitation conditions or parameters. In this embodiment, the first set of dissolved metal contaminants are removed by a first EC cell and a first reactor. Since the precipitation parameters of the second set of dissolved metal contaminants are different from those of the first set of dissolved metal contaminants, the second set of dissolved metal contaminants continue to remain in a soluble form in the treated intermediate water stream W2 exiting the first reactor. The second set of dissolved metal contaminants are removed, or their concentrations are reduced by further treating the treated intermediate water stream W2 in at least a secondary EC cell and a secondary reactor. The secondary EC cell and the secondary reactor function in the manner described above.

The following paragraphs describe some of the contemplated implementations/embodiments of the EC cell and reactor arrangement.

FIG. 3 shows treatment of a water stream W1 having a near neutral pH and containing dissolved iron and lithium. Iron and lithium have very different precipitation parameters including very different minimum solubility pH values and different requirements for dissolved metal anode concentrations.

Continuing with FIG. 3, the water stream W is received in a first EC cell 300 which contains magnesium anode pellets. In the EC cell 300, conditions are created including forming of in-situ coagulants and raising of the pH value of the water stream W to pH 10.0 or greater to enable precipitation of dissolved iron.

The water stream with the changed pH from EC cell 300, namely intermediate water stream W1, is received in reactor 302 where the changed pH of W1 is maintained and W1 is allowed to dwell till such time precipitation of dissolved iron into flocs of a desired density and size is completed. The flocs are removed from W1, block 304, by known separation techniques in a separator operatively coupled to the reactor 302. The separator may be a gravity separator or a flotation separator or a filter. The separated solids are dewatered, block 306, prior to safe disposal or refining.

Since the precipitation parameters for iron and lithium are different, the treated intermediate water stream W2 still contains the dissolved lithium. To remove lithium, W2 is further treated in a secondary EC cell 308 and a secondary reactor 310. W2, with the alkaline pH, is received in EC cell 308 for further treatment. EC cell 308 contains aluminum anode pellets which are dissolved to introduce aluminum ions into W2, and conditions are created for enabling precipitation of dissolved lithium. W2, after further treatment in the EC cell 308, is received in reactor 310 as a second intermediate water stream W3. Sufficient dwell time to W3 is provided in reactor 310 to complete precipitation of lithium as, but not limited to, lithium meta-aluminate (LiALO₂), lithium carbonate (Li₂CO₃) or lithium hydroxide (LiOH). The lithium flocs are separated or removed, block 312, and the separated flocs are dewatered, block 314, to produce a lithium solids cake for refining to produce lithium metal. Treated water, treated second intermediate water stream W4, is sent for reuse or returned to source.

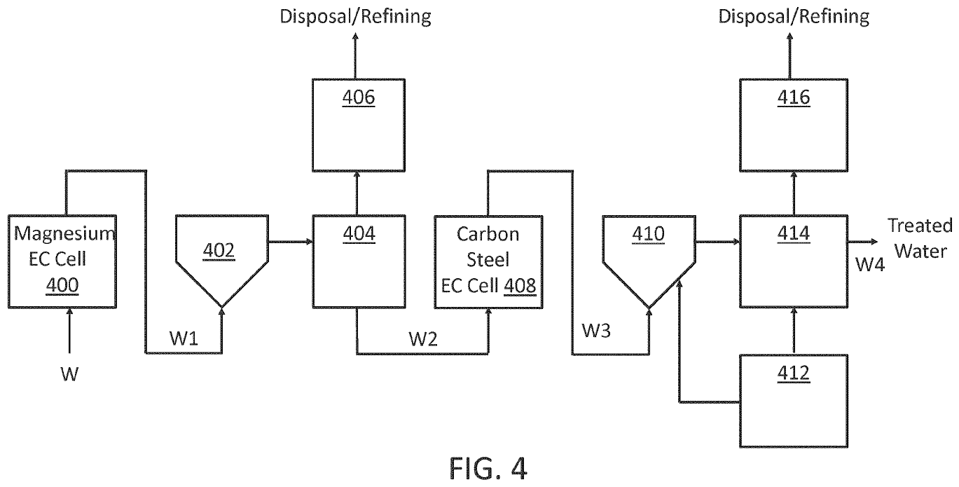

FIG. 4 shows treatment of a water stream W having a near neutral pH, a redox potential of 0 to 100 mv, and containing dissolved cadmium, copper, zinc and antimony. Cadmium, copper and zinc have similar precipitation parameters, while antimony precipitates under very different conditions.

Continuing with FIG. 4, the water stream W is received in a first EC cell 400 which contains magnesium anode pellets. In the EC cell 400, conditions are created including forming of in-situ coagulants, raising of the pH value of the water stream W to pH 11, and lowering the redox potential to less than −100 mV to enable precipitation of dissolved cadmium, copper and zinc into their insoluble form.

The water stream with the changed pH and redox potential from EC cell 400, namely intermediate water stream W1, is received in reactor 402 where the changed pH and redox potential of W1 is maintained and W1 is allowed to dwell till such time chemical reactions for conversion of dissolved cadmium, copper and zinc into flocs (insoluble form) of a desired density and size are completed. The flocs are removed and separated from W1, block 404, and the separated solids are dewatered, block 406, prior to safe disposal or refining.

Since the precipitation parameters for antimony are different from those of cadmium, copper and zinc, the treated intermediate water stream W2 still contains the dissolved antimony. To remove antimony, W2 is further treated in a secondary EC cell 408 and a secondary reactor 410. W2, with the alkaline pH, is received in EC cell 408 containing carbon steel anode pellets for further treatment. In EC cell 408 the carbon steel anode pellets are dissolved to introduce ferrous iron ions into W2 and conditions are created for precipitating antimony as a co-precipitate of iron. The treated water stream from EC cell 408, W3, is received in reactor 410 where sufficient dwell time is provided for completing precipitation of antimony as an iron-antimony co-precipitate. As one skilled in the art will understand, additional process steps, block 412, may be required to enable co-precipitation and formation of flocs such as oxidation of ferrous iron to its less soluble form. The flocs are removed from W2, block 414, and the separated flocs are dewatered, block 416, to produce a dry cake for disposal or refining to produce antimony metal. Treated water can be reused or discharged to the environment.

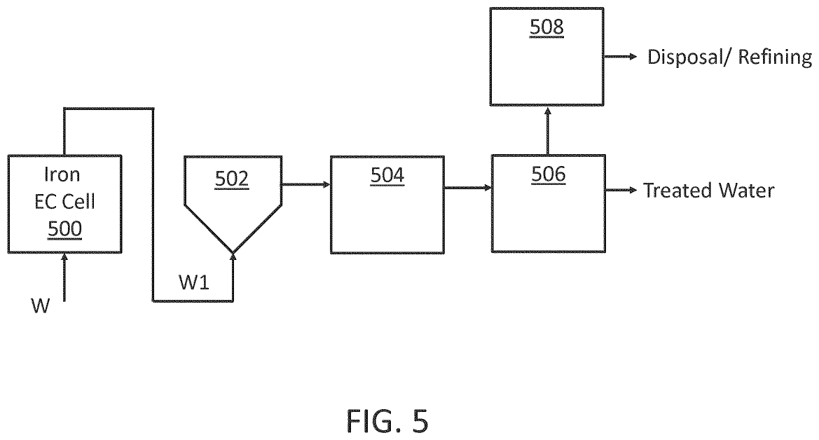

FIG. 5 shows treatment of a water stream W from a coal mine having elevated concentrations of dissolved selenium as selenate. The water stream W is received in EC cell 500 which contains carbon steel anode pellets. In EC cell 500, carbon steel anode pellets are dissolved to form in-situ coagulants of ferrous iron and reducing conditions are created. Dwell time for the water stream W1 exiting EC cell 500 under the reducing conditions initiated by EC cell 500 is provided in reactor 502 which enables reduction of selenate into selenite and its adsorption onto ferrous iron. To aid removal of dissolved ferrous iron with adsorbed selenite, additional process steps such as oxidation of the treated water to convert highly soluble ferrous iron to its less soluble ferric iron form are carried out, block 504. The resulting flocs containing co-precipitates of ferric iron-selenite are removed by a media filter, flotation cell or membrane, block 506, and the treated water W2, containing substantially lowered concentrations of selenium, is discharged to the environment. The flocs from block 506 are dewatered in a filter press, block 508, to produce a dry solids cake for refining or secure disposal.

1. A system for treating a water stream, having a first set of chemical characteristics, for reducing concentrations of at least a first set of dissolved metal contaminants contained therein, the system comprising:
an electrocoagulation (EC) cell having at least an electrode assembly, the EC cell adapted to receive the water stream and change the first set of chemical characteristics of the water stream to a second set of chemical characteristics to enable precipitation of the first set of dissolved metal contaminants; and
a reactor operatively coupled to the EC cell, the reactor adapted to receive the water stream from the EC cell as an intermediate water stream and provide a pre-determined residence time to the intermediate water stream to facilitate completion of the precipitation of the first set of dissolved metal contaminants and formation of flocs of a desired density and size for separation of the flocs from the intermediate water stream to generate a treated intermediate water stream.

2. The system of claim 1, wherein the reactor is a sealed vessel having a conical bottom.

3. The system of claim 1, wherein the flocs are separated in the reactor using gravity settling or flotation or filtration.

4. The system of claim 1, wherein the flocs are separated in a separator operatively coupled to the reactor.

5. The system of claim 4, wherein the separator is a gravity separator or a flotation separator or a filter.

6. The system of claim 1, wherein the electrode assembly comprises one or more spaced apart electrode rods supported within a reactive bed of metal pellets, and wherein the reactive bed of metal pellets functions as a consumable anode, and wherein the electrodes are adapted to be stimulated by an electrical power source for dissolving the metal pellets into the water stream.

7. The system of claim 1, wherein the pre-determined residence time in the reactor ranges from about 5 minutes to about two hours.

8. The system of claim 1, wherein the flocs have a density ranging from about 0.9 mg/ml to about 2 mg/ml, and size ranging from about 0.1 mm to about 10 mm in diameter.

9. The system of claim 1, further comprising at least a secondary EC cell and at least a secondary reactor for reducing concentrations of a second set of dissolved metal contaminants contained in the water stream, wherein the second set of dissolved metal contaminants has precipitation parameters different from the first set of dissolved metal contaminants resulting in the second set of dissolved metal contaminants continuing to remain in a soluble form in the treated intermediate water stream.

10. A process for treating a water stream using the system of claim 1, the process comprising the steps of:
providing the system of claim 1;
receiving, in the electrocoagulation (EC) cell, the water stream;
in the EC cell, forming in-situ coagulants and changing the first set of chemical characteristics of the water stream to the second set of chemical characteristics for enabling the precipitation of the first set of dissolved metal contaminants;
receiving in the reactor the water stream from the EC cell as the intermediate water stream; and
retaining the intermediate water stream in the reactor for the pre-determined residence time while maintaining the second set of chemical characteristics for facilitating the completion of the precipitation of the first set of dissolved metal contaminants and formation of the flocs of the desired density and size; and
removing the flocs from the intermediate water stream to generate the treated intermediate water stream.

11. The process of claim 10, wherein the reactor is a sealed vessel having a conical bottom, and wherein the step of receiving in the reactor further comprises flowing the intermediate water stream through the sealed vessel in an up flow pattern, from a bottom end of the sealed vessel it its top end.

12. The process of claim 10, wherein the step of retaining the intermediate water stream in the reactor for the pre-determined residence time further comprises retaining the intermediate water stream in the reactor for about 5 minutes to about two hours.

13. The process of claim 10, wherein the step of removing the flocs further comprises removing the flocs in the reactor using gravity settling or flotation or filtration.

14. The process of claim 10, wherein the step of removing the flocs further comprises removing the flocs in a separator operatively coupled to the reactor using gravity settling or flotation or filtration.

15. The process of claim 10, wherein the step of forming in-situ coagulants comprises stimulating the electrode assembly housed in the EC cell by an electrical power source.

16. The process of claim 15, wherein the step of stimulating further comprises stimulating by an AC power source.

17. The process of claim 16, wherein the electrode assembly includes one or more spaced apart electrode rods supported within a reactive bed of metal pellets, and wherein the reactive bed of metal pellets functions as a consumable anode, and wherein the step of forming in-situ coagulants further comprises stimulating the electrodes by the AC power source and dissolving the metal pellets to introduce metal ions into the water stream.

18. The process of claim 17 further comprising further treating the treated intermediate water stream in at least a secondary EC cell and at least a secondary reactor for reducing concentrations of a second set of dissolved metal contaminants contained in the water stream, wherein the second set of dissolved metal contaminants has precipitation parameters different from the first set of dissolved metal contaminants resulting in the second set of dissolved metal contaminants continuing to remain in a soluble form in the treated intermediate water stream.

19. The process of claim 18, wherein the precipitation parameters include minimum solubility pH values.

20. The process of claim 18, wherein the water stream has a neutral pH and wherein the first set and second set of dissolved metal contaminants are dissolved iron and dissolved lithium, respectively, the process further comprising:
in the EC cell, at least changing the neutral pH of the water stream to an alkaline pH by introducing magnesium ions for enabling precipitation of iron and generating the intermediate water stream;
retaining the intermediate water stream in the reactor while maintaining the alkaline pH for facilitating completion of the precipitation of dissolved iron and formation of flocs of iron;
removing the flocs of the iron and generating the treated intermediate water stream, the treated intermediate water stream containing the dissolved lithium;
in the secondary EC cell, introducing aluminum ions into the treated intermediate water stream for enabling precipitation of lithium and generating a second intermediate water stream;
in the secondary reactor, retaining the second intermediate water stream for facilitating completion of the precipitation of lithium into an insoluble form and formation of flocs of lithium; and
removing the flocs of lithium from the second intermediate water stream and generating a treated second intermediate water stream.

21. The process of claim 10, wherein the first set of dissolved metal contaminants are selenium, the process further comprising:
in the EC cell, forming ferrous iron coagulants and decreasing a redox potential of the water stream for enabling precipitation of selenium as selenite and generating the intermediate water stream;
retaining the intermediate water stream in the reactor for facilitating formation of selenite and its adsorption onto the formed ferrous iron coagulants and forming flocs containing co-precipitates of iron-selenite; and
removing the flocs from the intermediate water stream and generating the treated intermediate water stream.

22. The process of claim 21, wherein the step of forming flocs further comprises converting ferrous iron to ferric iron.

23. The process of claim 10, wherein the step of removing the flocs further comprises removing flocs having a density ranging from about 0.9 mg/ml to about 2 mg/ml, and size ranging from about 0.1 mm to about 10 mm in diameter.

24. The process of claim 10, wherein changing the first set of chemical characteristics of the water stream includes changing a pH value or a reduction oxidation potential value or both the pH and reduction oxidation potential values of the water stream.
